(19) United States
(12) Patent Application Publication
(10) Pub. No.: US 2005/0102662 A1
(43) Pub. Date: May 12, 2005

(54) PCTEL-13800U automated updating system for wireless networks

(75) Inventors: Vojislav Samsalovic, Chicago, IL (US); Robert Boxall, Elmhurst, IL (US)

Correspondence Address: PILLSBURY WINTHROP LLP, 2475 HANOVER STREET, PALO ALTO, CA, 94304-1114, US

(73) Assignee: PCTEL, Inc., Chicago, IL (US)

(21) Appl. No.: 10/946,402

(22) Filed: Sep. 20, 2004

Related U.S. Application Data
(60) Provisional application No. 60/504,152, filed on Sep. 19, 2003.

(51) Int. Cl. G06F 9/44; G06F 9/445; G06F 15/173

(52) U.S. Cl. 717/168; 717/174; 709/223

(57) ABSTRACT

A system and method are disclosed that allow information to be transmitted to a device in order to update or upgrade the device. Thus, a client can be updated from a central location in real-time after the client has been deployed. The system and method disclosed in accordance with the present invention also allows for an automated or user initiated updates to software or device configuration.

### CROSS-REFERENCE

This application claims the benefit of and incorporates by reference U.S. Provisional Patent Application Ser. No. 60/504,152; entitled “Automated Updating System for Wireless Networks”.

### BACKGROUND OF THE INVENTION

This invention is related to communication systems and more particularly to performing updates, including software and configuration, in the context of wired and wireless networks.

In a typical communication system that includes a wireless communication device updating the device is a time consuming and inefficient process. The device will typically be taken back to the original point of purchase in order to have the update or upgrade installed. Some devices can not be updated or upgraded and, hence, a new device must be purchased.

Furthermore, in situations relating to correction of errors or a “bug-fix” in a software program, the process of replacing the software or altering the phone configuration will be costly and inefficient. Additionally, current systems are not able to track and provide updates information to the device relating to the location of hot-spots and changes relating to hot-spots.

Therefore, what is needed is a system and method for updating a device with current information that allows for the capability for over-the-air downloading of information independent of the location of the device.

### SUMMARY OF THE INVENTION

A system and method are disclosed that allow information to be transmitted to a device in order to update or upgrade the device. Thus, a client can be updated from a central location in real-time after the client has been deployed. The system and method disclosed in accordance with the present invention also allows for an automated or user initiated updates to software or device configuration.

The method for updating a device includes the steps of initiating communication from the client to a parent server; determining if the client has the most recent update by comparing the time stamp information of at the client with the time stamp information of the current update available at the server; and if necessary, then downloading the necessary information to the client.

The system includes a device that includes at least one updatable component and is capable of transmitting authentication information to a server that is in communication with the device, wherein the server is capable of downloading updates to the device when the device has been authenticated by the server.

### BRIEF DESCRIPTION OF THE DRAWINGS

FIG. 1 illustrates a client in communication with a server in accordance with the teachings of the present invention;

FIG. 2 illustrates a client in communication with a plurality of servers in accordance with the teachings of the present invention;

FIG. 3 illustrates an updater for handling updates that are sent to the client in accordance with the present invention;

FIG. 4 illustrates the communication process between the updater and a server; and

FIG. 5 illustrates the process of downloading updates from a server to a client.

### DETAILED DESCRIPTION OF THE INVENTION

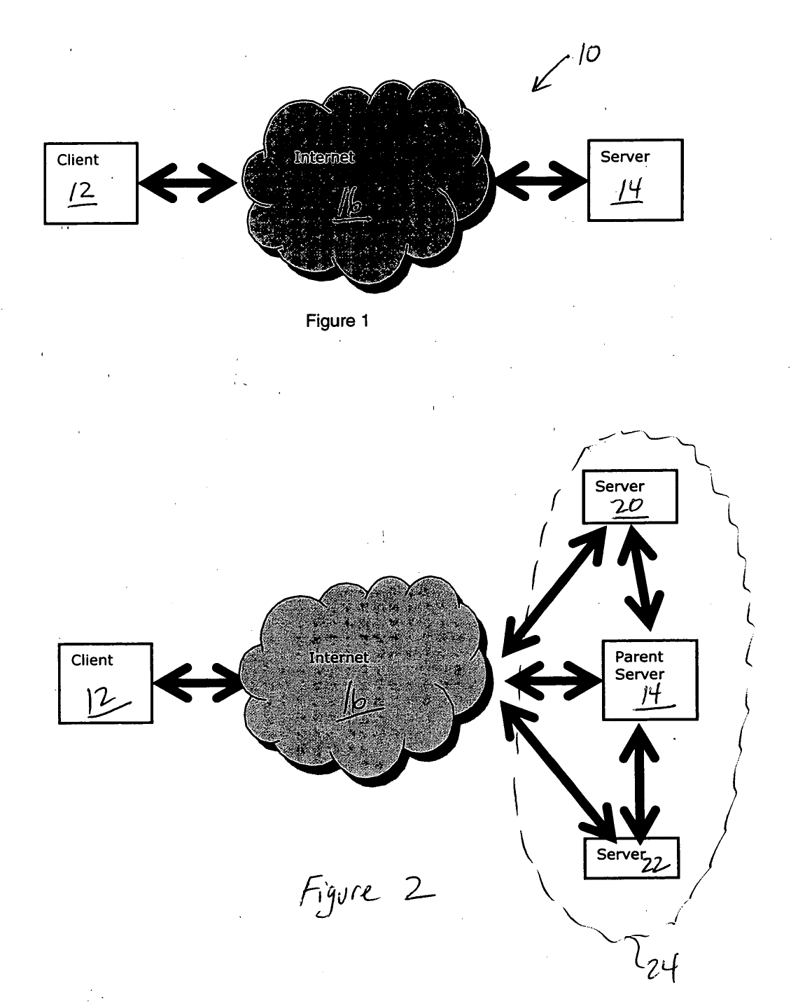

Referring now to FIG. 1, a communication environment 10 is shown wherein a client 12 is communicating to a server 14 over the network 16, which can be either an intranet or the Internet. It will be apparent to those skilled in the art that a server includes one or more computers. The term client and device are used interchangeably herein and it will be apparent to those skilled in the art that clients are devices and software or objects that use resources from or with another object. The intent is that the client or device is capable of identifying itself to a server and sending appropriate information to the server that is contacted. Thus, the client can be a device or generic software that is resident on the device, which has certain configurations and pre-programmed with certain data. The server 14 authenticates the client 12 and can send information, such as upgrades and configuration data, to the client 12 as detailed below. The server provides updates, which is required for continuous operation, as well as current information to the client 12. For example; information relating to changes in the locations of hotspots, the service provider agreements can change impacting the geographical cost of using the network, and the client 12 may require upgrades or new drivers for continued successful operation.

In one embodiment, communication is via XML between the client 12 and the server 14 over the Internet 16. A secure communications channel may be desired in at least some instance, such as one exemplary embodiment wherein communications are carried using HTTPS. Such a secure communication can be used in instances wherein the client is providing authentication information required in order to gain access to information controlled by the server 14.

Referring now to FIG. 2, the system 10 of FIG. 1 is shown with the server 14 in communication with a plurality of servers is shown. The server 14 is a central server that is communication with at least one other server. In such a configuration the server 14 may also be referred to as a central server or a central configuration server (CCS). In this specific example shown, servers 20 and 22 are in communication with the server 14 and the client 12. Thus, the server 14 provides an interface between the client 12 and the servers 20 and 22 in order to facilitate software and configuration updates. Any one of the servers 14, 20, and 22 can contain the update information and the servers working together through the central server are also referred to hereinafter as an updater 24. The updater 24 communicates with the client 12, which is a wireless devices in the specific example but can also be a wired device and the scope of the present invention is not limited thereby.

In one embodiment the updater is a part of the server and in an alternative embodiment the updater is in communication with the server but positioned in a remote location, both of which are discussed in detail below.

In an alternative implementation, the CCS handles actual communications traffic (implemented in hardware and/or as a software functionality) as well as sending the update information.

In accordance with the teaching of the present invention the client can be automatically updated the client or the user can initiate and update from the client. Both of these processes are discussed in detail below.

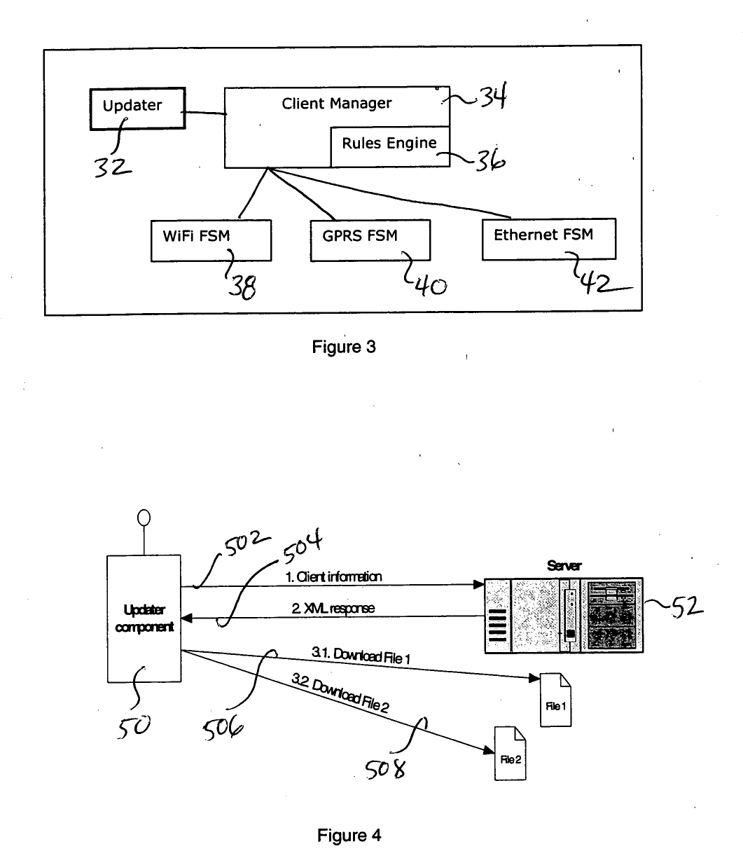

Referring now to FIG. 3, one embodiment is shown with a server 30 that includes an updater 32 coupled to a client manager 34. The client manager includes an engine 36 that contains the rules for updating the client. The client manager 34 is also coupled to the various file server managers (FSM), such as WiFi FSM 38, a GPRS FSM 40, and Ethernet FSM 42. The updater 32 manages communication between the client server 34 and the client, so that communication between the client and the server 30 is handled according to the rules. When a communication session for updates is initiated between the client and the server 30, the updater 32 checks for updates of various files or components of the code base without regard to type. In this embodiment, the updater 32 is kept in a dynamically linked library (DLL) and resides with the main client application or software. In an alternative arrangement, the updater is held in a separate DLL and sits with the main client application, such as shown in FIG. 3. If the updater 32 determines that updates are available to be downloaded to the client, then the downloads of the files or other components can be initiated. The process of downloading the updates can either occur automatically or a user can be prompted to begin an update download.

The updater 32 and the DLL relating to the updater 32 is configured to also send key information about the parent server. In some embodiments, it may be desirable to keep to user interface (UI) separate from the updater core. This is not required in all embodiments, and in such embodiments the UI can be retained within the DLL. The parent server is the server that the device initially contacts when the device is turned on or activated for the first time. The URL of the parent server is stored in the client and the parent server has the information about the device stored for authentication reasons. Once the client contacts that parent server, then the client is able to obtain and download updates as determined by the information stored in the device relative to the most current information maintained by the updater.

Once the initial contact has been established between the client and the parent server, thereafter the client will first contact the parent server in order to obtain updates through the updater. In alternative embodiments, the URL for the parent server may also be the same at the URL for the updater when the parent server and the updater are one and the same device. The parent server, in future update sessions, can provide a new URL for the client to contact during that specific update session; at the next update session the client would again contact the same parent server. However, at any time following an update session, the parent server has the ability to provide a new URL to the client and assign the server at the new and different URL to be the parent server for the client for future update communication sessions. Thereafter, the client would contact the new parent server and not the old parent server.

In operation, the updater 32 sends notifications to the correct technology element whenever the updater 32 obtains at least one downloaded file, and the downloaded file is maintained available by the updater 32 until needed for an update session. If an update with more than one file is created on the CCS, the updater 32 can be instructed to download all files within a single transaction. The updater 32 will recognize the update as successful if all files within a transaction were downloaded correctly.

In an alternative embodiment, the updater 32 is configured to send notifications when the updater 32 learns that an update is available on the server or CCS. In such an arrangement, the updated file may be maintained in a repository until the element of the CCS notifies the updater 32 that the element is ready to receive the updated file, at which time the updater 32 facilitates the transfer of the file to the element requesting the update. For example, if a WiFi partner update is received from a carrier, the updater 32 informs the WiFi DLL that there is a new update. The WiFi element can then reload the new update rather than using the old data or information that was previously loaded. Thus, the new update will be available the next time the client initiates an update session and check for updates.

Any component application of the client will be able to register with the updater 32 for the files that it requires and the client manager 34 will be able to register its own components. It will be appreciated that the client manager includes a plurality of software components configured according to the needs of a particular implementation. In one arrangement, the CCS may be configured to tell the appropriate other components of the system what files go to what DLL. In addition, certain statistics may be passed back to the CCS, although alternatively such statistics may be part of the client to infrastructure API, discussed hereinafter. In each instance, the data for registration typically includes a string that represents the type of technology associated with the code, such as WiFi, GPRS, CDMA, location finder, and so on. Version, update or other information can also be provided during this update session.

In each instance, the data for registration typically includes an identification string that represents the type of update the component is requesting, such as WiFi, GPRS or CDMA networks configurations, Location Finder data, and so on. The server generated timestamp of the last successfully downloaded update has to be provided, while software version and other client information is optional.

In one embodiment, there are two interfaces between the client and the network or the Internet in order to reach or contact the server. First, the client talks to the local hotspot for local communication and authentication. Second, a link is established between the client and the service provider for status information, customer provisioning and other push type services that the provider may require to be implemented. With regard to the first interface, there are several different hotspot Application Program Interfaces (APIs) that exist in today's market, including
WISPr
AWS
Cometa
Colubris
Screen scraping
   These interfaces are driven or provided to the client via configuration settings in the CCS or server. The CCS can hold a list of networks in order of priority and list the method to use at each. New roaming partners can be easily added to the CCS and distributed transparently to the client.

As indicated above, in addition to the interface between the client and the local hotspot there is the secure link between the client and its service provider. This communication interface enables the client to inform the provider of its current status in its operating environment and allows for the provider to push instructions to the client. The decision on what instructions should be sent to the client is determined based on the client's current status and other information identifying the client as an entity. The service provider can change the logic on what instructions should be sent to the client as often as necessary as the client shall always ask for the most up-to-date decision. The communication link is, at least in some embodiments, via HTTPS. The messages from the client typically contain information about the current state of the device, such as the time-stamp for the latest update. The following UI elements are needed:
Balloon notification;
Dialog notification;
Download; and
Configuration

In at least some embodiments, the updater 32 is not aware of the client's parent server 30 network connection status or the type of bandwidth that a connection permits. Thus, the updater 32 is not in a position of being able to drive communication with the server. In such embodiments, a control interface is provided which allows for the updater 32 to be told when it can try to check for an update. This interface, which may be in the form of a message, may also inform the updater of the type of connection. Additionally, the control interface allows for a user to initiate a ‘check updates now’ process, which is essentially a manual start to the automated process described above.

Referring now to FIG. 4, the updater 50 initiates communication with the server or CCS 52 by sending the following parameters via HTTP(S) POST in exemplary XML form, which is also used to store settings and provide communication between the client and the update server:

| | Client | Parameter | | |
|---|---|---|---|---|
| No. | Information | Name | Required | Example |
| 1. | Vendor Code | vendor | required | PCTEL |
| 2. | Product Code | product | required | RC_WIFI_{—} |
| | | | | GPRS |
| 3. | Version Number | version | required | 2.64.00 |
| 4. | Serial Number | serialnumber | required | 123456789 |
| 5. | Timestamp of the | lastupdate | required | 2003-08-13 |
| | last successful | | | 17:13:19.12 |
| | update | | | |
| 6. | Operating System | os | optional | |
| | Name | | | |
| 7. | IP address of the | ip | optional | |
| | client | | | |
| 8. | Production or Test | test | optional | 0 |
| | mode | | | |

The following sets forth examples of the communications between the Updater 50 and the CCS 52; Updater 50 POSTs client information to CCS 52 at path 501:
https://ccs.pctel.com/GetSomeUpate
   POST
   vendor=PCTEL
   product=RC_WIFI_GPRS
   version=2.64.00
   serialnumber=123456789
   lastupdate=2003-08-13 17:13:19.12

CCS 52 responds by returning a well formatted XML response specifying the file(s) that are available for download at path 504:

```
<?xml version=”1.0” encoding=”UTF-16”?>
<files id=”ID1” transaction=”no”>
  <file id=”file1” silent=”no” compressed=”yes” method=”full”>
    <remote>https:// server1.ccs.com/downloads/File1.zip</remote>
    <desc>An updated list of carrier defined WiFi networks is available
      for download. Do you want to download now?</desc>
    <size>22048</size>
    <localbase>CSIDL_COMMON_APPDATA</localbase>
    <local>PCTEL_Networks.xml</local>
    <lastupdate>2003-08-16 12:16:11.12</lastupdate>
  </file>
  <file id=”file2” silent=”no” compressed=”yes” method=”full”>
    <remote>https://server1.ccs.com/downloads/File2.zip</remote>
    <desc>An updated list of company defined WiFi networks is
      available for download. Do you want to download now?</desc>
    <size>12048</size>
    <localbase>CSIDL_COMMON_APPDATA</localbase>
    <local>PCTEL_Co_Networks.xml</local>
    <lastupdate>
  </file>
</files>
```

If there are no files available for download, CCS returns an empty files list.

<?xml version=”1.0” encoding=”UTF-16”?>
<files/>

XML response syntax

| Element | Description |
|---|---|
| Silent | Download mode - silent: yes/no. If equals ‘yes’, updater |
| | should download file without prompting the user. |
| compressed | File is compressed and should be uncompressed once it's |
| | downloaded. |
| method | - Update method: ‘FULL’ - whole file needs to be |
| | replaced. ‘PARTIAL’ - only a piece of information |
| | needs to be updated. |
| <size> | Update file size in bytes. |
| <local> | Local file name. |
| <desc> | Short text description updater uses to inform the user about |
| | the update purpose. |
| <remote> | URL location of the update file. |
| <lastupdate> | Timestamp when the update file was created. |
| <localbase> | Absolute path where the download file should be saved on |
| | the device. |

The updater 50 starts downloading file(s) from the specified remote location(s) at path 506 and 508. In addition, a system which incorporates the foregoing invention may also include an API to facilitate communications between the central server and remote devices. The API, which can be used independently, is provided to permit a diverse universe of devices to communicate successfully with the system of the present invention. The following exemplary information is representative of a typical API in accordance with the present invention.

More particularly, this aspect of the invention is directed to the client to infrastructure API for a client capable of seamless roaming among wireless networks, sometimes referred to hereinafter as a “Smart Client” or “Roaming Client”. This interface is designed to allow both pre and post authentication communications between a Smart Client and a carrier's infrastructure.

The majority of providers of paid Wi-Fi services are looking to rapidly augment their native networks through the addition of Wi-Fi roaming partners. The Roaming Client and the CCS provide the ability for a carrier to continually add network authentication and connection logic for each roaming partner and to deploy that logic to users in the field. In addition, a separate provisioning API allows carriers to continue to use their existing self service provisioning and account maintenance website while integrating this capability into the Roaming Client itself. Thus, the present invention permits providers to integrate the Smart Client solution with their network offerings.

Interface Design: States

The interface supports the client sending various connection states to the infrastructure. For example, when the client first connects and is in the pre-authentication state a pre-authentication message is sent. This message will contain the state as given in Table 1 entitled Smart Client STATES and the information from the Info state defined in Table 2 entitled INFO.

TABLE 1
Smart Client STATES

| Name | Description | XML Syntax |
|---|---|---|
| 1. Connected | Client is connected to a wireless | <status>connected |
| | network. | </status> |
| 2. Loggedin | Client has successfully performed | <status>loggedin |
| | Login operations using Login API. | </status> |
| 3. Loginfailed | Client has attempted Login | <status>loginfailed |
| | operations, but the login has failed | </status> |
| | due to an error or some other | |
| | known or unknown problems. | |
| 4. Loggedout | Client has successfully performed | <status>loggedout |
| | Logout operations using Login | </status> |
| | API. | |
| 5. Logoutfailed | Client has attempted Logout | <status>logoutfailed |
| | operations, but the logout has | </status> |
| | failed due to an error or some | |
| | other known or unknown | |
| | problems. | |
| 6. Disconnect- | Client isn't connected to a wireless | <status> |
| ed | network, but it is able to send | disconnected |
| | status information through a LAN | </status> |
| | interface or other network | |
| | connection. | |

TABLE 2
INFO

| Name | Description | XML Syntax |
|---|---|---|
| 1. status | Status information is critical for | <status>loggedin</stat |
| | server side logic and determining a | us> |
| | set of actions that should be | |
| | performed by the client. | |
| | Required. | |
| 2. username | Username information is critical | <username>someuser |
| | for accessing user's account and | </username> |
| | displaying appropriate content for | |
| | user account status, If not | |
| | provided, the server assumes this | |
| | is a new customer. However, there | |
| | should be a link allowing existing | |
| | users to enter existing | |
| | usemame/password manually. | |
| | Required. | |
| 3. password | Password information is required | <password>somepass |
| | for accessing user's account. If not | </password> |
| | provided, the server should | |
| | prepopulate usemame field and | |
| | prompt user to enter password | |
| | before being able to access | |
| | account info. | |
| | Required. | |
| 4. error | Error codes should provide | <error>0</error> |
| | additional information about the | |
| | client status and why that | |
| | condition occurred. | |
| | Required. | |
| 5. provider | Provider identifier passed by the | <provider>CarrierXYZ |
| | local NAS. | </provider> |
| | Optional. | |
| 6. location | Location identifier passed by the | <location>wp_700</ |
| | local NAS. | location> |
| | Optional. | |
| 7. sessionid | Session identifier passed by the | <sessionid>12345</ |
| | local NAS. | sessionid> |
| | Optional. | |
| 8. ip | Current IP address of the wireless | <ip>216.12.231.204</i |
| | adapter. | p> |
| | Optional. | |
| 9. mac | MAC address of the wireless | <mac>00-06-25-0D- |
| | adapter. | 3A-24</mac> |
| | Optional. | |

Table 2 is merely an example of the types of information that can be send and is not intended as a limitation; various other types of information can be sent such as:

<status>connected</status>
<username>someuser</status>
<sessionid>123456789</sessionid>
<ip>63.142.45.23</ip>

Actions

The Application Carrier interface consists of various actions that can be performed. These actions are passed to the client from the infrastructure after the client sends a status message. These messages can either be embedded inside standard HTML or can be raw XML. These communications are done using HTTPS format though unsecured HTTP format can also be supported. The following is a sample list of the action and in not intended to be an exclusive or complete list of the action:

TABLE 3
Smart Client ACTIONS

| Name | Parameters | Example |
|---|---|---|
| 1. launchMiniBrowser | url | <action name=”launchMiniBrowser”> |
| | width | <parameter name=”url” type=”single”> |
| | height | <value>https://www.someurl.com</value> |
| | | </parameter> |
| | | <parameter name=”width” type=”single”> |
| | | <value>320</value> |
| | | </parameter> |
| | | <parameter name=”height” type=”single”> |
| | | <value>240</value> |
| | | </parameter> |
| | | </action> |
| 2. closeMiniBrowser | — | <action name=”closeMiniBrowser”/> |
| 3. login | attempts | <action name=”login”> |
| | | <parameter name=”attempts type=”single”> |
| | | <value>3</value> |
| | | </parameter> |
| | | </action> |
| 4. logout | — | <action name=”logout”/> |
| 5. setUserInfo | username | <action name=”setUserInfo”> |
| | accountURL | <parameter name=”username” |
| | | type=”single”> |
| | | <value>johndoe</value> |
| | | </parameter> |
| | | <parameter name=”accountURL” |
| | | type=”single”> |
| | | <value>htt//accounts.mc.com?id=johndoe</value> |
| | | </parameter> |
| | | </action> |
| 6. promptPassword | username | <action name=”promptPassword”> |
| | | <parameter name=”username” |
| | | type=”single”> |
| | | <value>johndoe</value> |
| | | </parameter> |
| | | </action> |
| 7. showDialog | message | <action name=”showDialog”> |
| | width | <parameter name=”message” type=”single”> |
| | height | <value>CarrierXYZ Message...</value> |
| | | </parameter> |
| | | <parameter name=”width” type=”single”> |
| | | <value>250</value> |
| | | </parameter> |
| | | <parameter name=”height” type=”single”> |
| | | <value>350</value> |
| | | </parameter> |
| | | </action> |
| 8. launchDefaultBrowser | url | <action name=”launchDefaultBrowser”> |
| | | <parameter name=”url” type=”single”> |
| | | <value>http://www.carrierXYZ.com</value> |
| | | </parameter> |
| | | </action> |
| 9. connect | — | <action name=”connect”/> |
| 10. disconnect | — | <action name=”disconnect”/> |

The CCS allows for a centrally managed interface for the client. The CCS is designed to function as a centralized management point for the connectivity logic of the Roaming Client and allow population of the location finder directory in deployed Roaming Clients. The CCS provides a management console for the administration of this data, or it can be configured to point to third party locations for this type of data. These configuration options of the CCS permit providers to easily incorporate new roaming partner networks into their service offering.

The CCS is able to create new Wi-Fi Roaming partner networks and to distribute this new connection logic to deployed Roaming Clients. The CCS has the functionality to add/remove roaming partners for a Wi-Fi service provider. An exemplary template for achieving this is as follows:

Modify Preferred Network

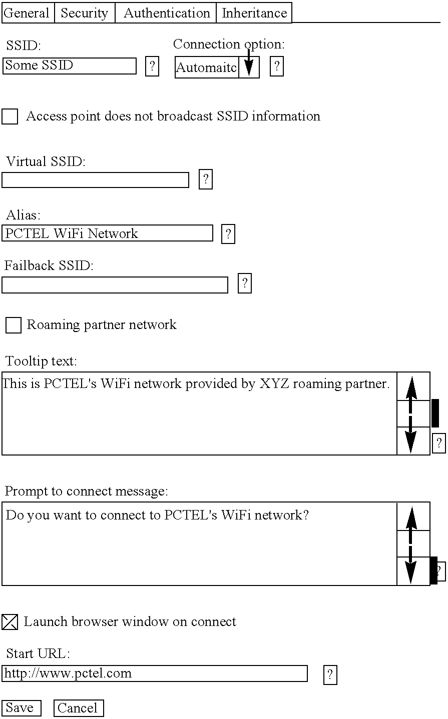

The client can “see” Wi-Fi networks in a manner determined by the CCS; that is, the client sees such networks in the way the CCS “tells” it to. In at least some embodiments, the client is aware of all available Wi-Fi networks, but the configuration information entered through and served by the CCS creates a network information abstraction layer, so the client's users can see information defined by the carrier/provider to which the user subscribes. Each Wi-Fi network is defined by its SSID information, as shown in the template, above. However, the CCS creates configuration files that alias this information and provide additional information presented to the users. Such information includes more detailed network description, starting URL, connection options (Automatic/Prompt/Manual), and so on.

| | |
|---|---|
| - | <network closed=“no” connect=“prompt” owner=“PCTEL” |
| | roaming=“yes”> |
| | <ssid>SomeSSID</ssid> |
| | <alias>PCTEL WiFi Network</alias> |
| | <memo>This is PCTEL's WiFi network provided by XYZ |
| | roaming partner.</memo> |
| | ... |
| - | <browser launch=“yes” useproxy=“no”> |
| | <starturl>http://www.pctel.com</starturl> |
| | </browser> |
| | ... |

</network>

Hotspot API Settings

In one embodiment, the CCS includes the functionality to add/remove hotspot settings for roaming partners for a Wi-Fi service provider. In an exemplary arrangement, hotspots information is maintained through a user-friendly CCS user interface (UI). Typically, although not necessarily in all embodiments, all information is stored in relational database format to provide fast and flexible data search and modification. Further, in a typical arrangement, the update files for hotspots settings are provided in a scalable XML format that allows simple and flexible manipulation on the Client. A template reflecting how a table of hotspots is maintained is show below:

Locations

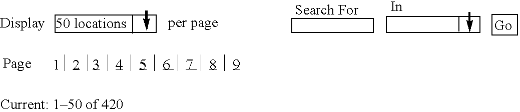

| No. | Name | Address | City | State | County | Test | Action |
|---|---|---|---|---|---|---|---|
| 1. | Airport | Hilton Airport | Chicago | IL | USA | □ | delete |
| 2. | Barton Creek Resort and Club | 8212 Barton Club Drive | Austin | TX | USA | □ | delete |
| 3. | Beechwood Hotel—Worcester | 383 Plantation Street | Worcester | MA | USA | □ | delete |
| 4. | Bertram Inn & Conference Center | 600 North Aurora Road | Aurora | OH | USA | □ | delete |
| 5. | Best Western Cedar Park Inn | 5116 Calgary Trail Northbound | Edmonton | Alberta | Canada | □ | delete |
| 6. | Best Western Getaway Hotel Santa Monica | 1920 Santa Monica Blvd. | Santa Monica | CA | USA | □ | delete |

In addition, an exemplary template for adding a hotspot is shown in the table below:

Modify Location

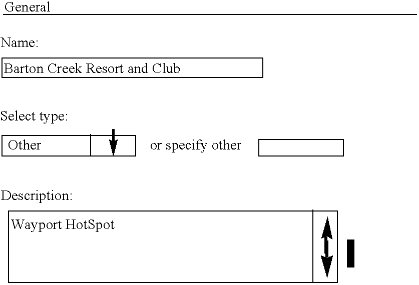

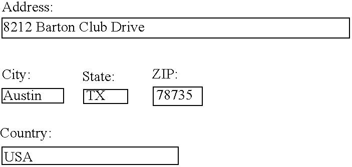

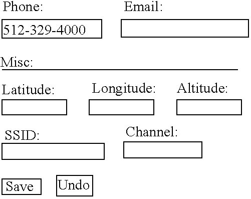

Exemplary code for such a hotspot is show below:

<?xml version=“1.0” encoding=“UTF-16” ?>

| - | <ArrayOfHotSpot lastupdate=“2003-09-12 16:45:17.625” version= | |
|---|---|---|
| | “1.0”> | |
| | - | <HotSpot> |

<Name>D/FW International Airport Terminal E</Name>
<Address>PO Drawer 619428</Address>
<City>DFW Airport</City>
<State>TX</State>
<Zip>75261</Zip>
<Location>Wayport HotSpot</Location>
<Category>Airport</Category>
<Country>USA</Country>

...

</HotSpot>

Carrier API Settings

The basic CCS functionality for adding or removing carrier interface settings for roaming partners for a Wi-Fi service provider is described below in an exemplary format.

Modify Preferred Network

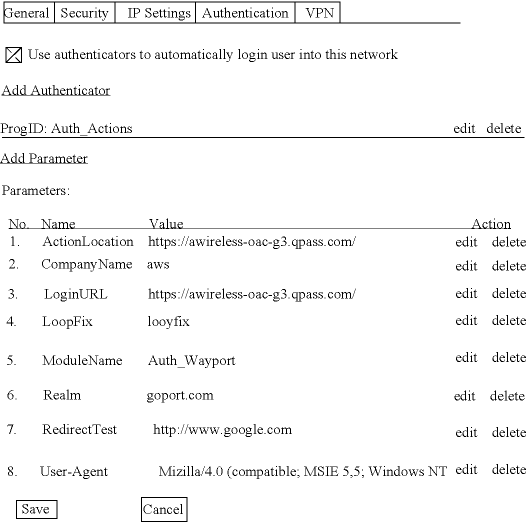

The CCS provides a convenient and flexible way to define carrier and/or roaming partner specific procedures for authentication and logging into Wi-Fi networks. In an exemplary arrangement, each network can have any number of API settings defined for it. The API settings are expressed in the form of Authenticator objects and associated parameters. Each Authenticator can have any number of parameters. Using this mechanism, CCS provides a mean to dynamically change the way the client operates in different network environments. Flexible configuration files (see below) allow defining any number of Authenticator objects which are executed in the order of significance. If the Authenticator object with higher priority fails, the Client automatically instantiates the next Authenticator from the list. Exemplary code for such an Authenticator is illustrated below:

- <authentication launch=“yes” prompt=“no”>
- <authenticator method=“API” progID=“Auth_Actions”>

<parameter

name=“ActionLocation”>https://awireless-
oac-
g3.qpass.com/wificontrollerservlet/</paramet
er>

<parameter

name=“CompanyName”>aws</parameter>

<parameter

name=“LoginURL”>https://watergate.corp.au
s.wayport.net/roamer_login.adp</parameter>

<parameter

name=“LoopyFix”>loopyfix</parameter>

<parameter

name=“ModuleName”>Auth_Wayport</param
eter>

<parameter

name=“Realm”>goport.com</parameter>

<parameter

name=“RedirectTest”>http://www.google.com
/index.html</parameter>

<parameter name=“User-Agent”>Mozilla/4.0

(compatible; MSIE 5.5; Windows NT 5.0) -
AWSWiFiManager/1.0</parameter>

</authenticator>

<authenticator>
...
</authenticator>
...
</authentication>

Sign Up Procedure

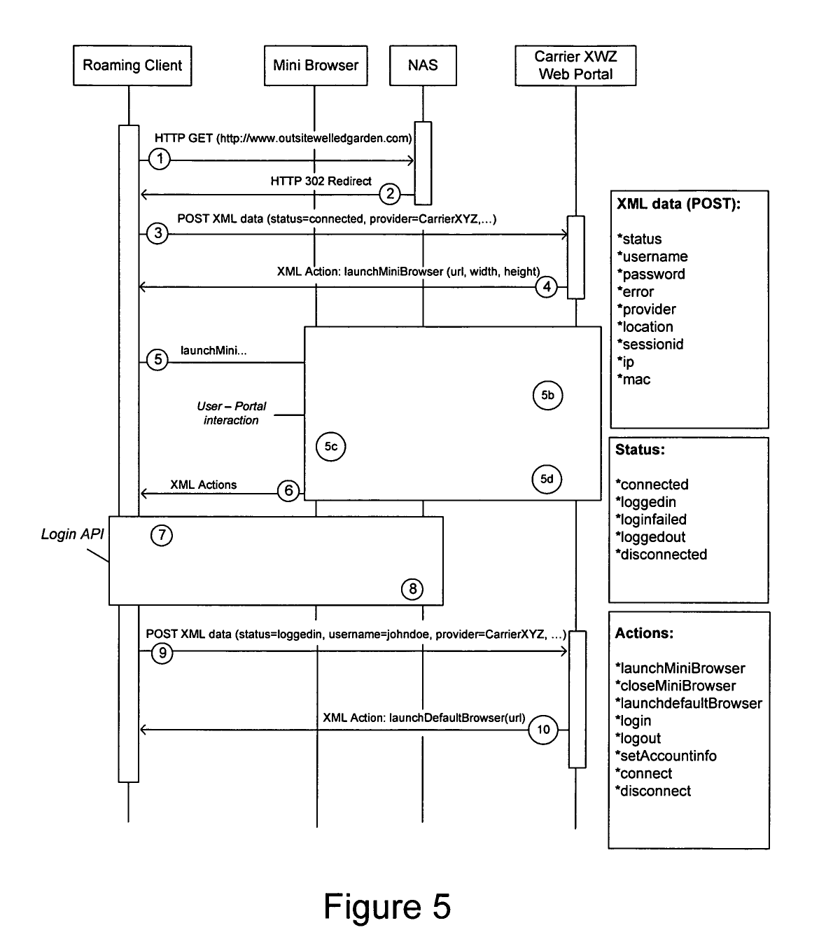

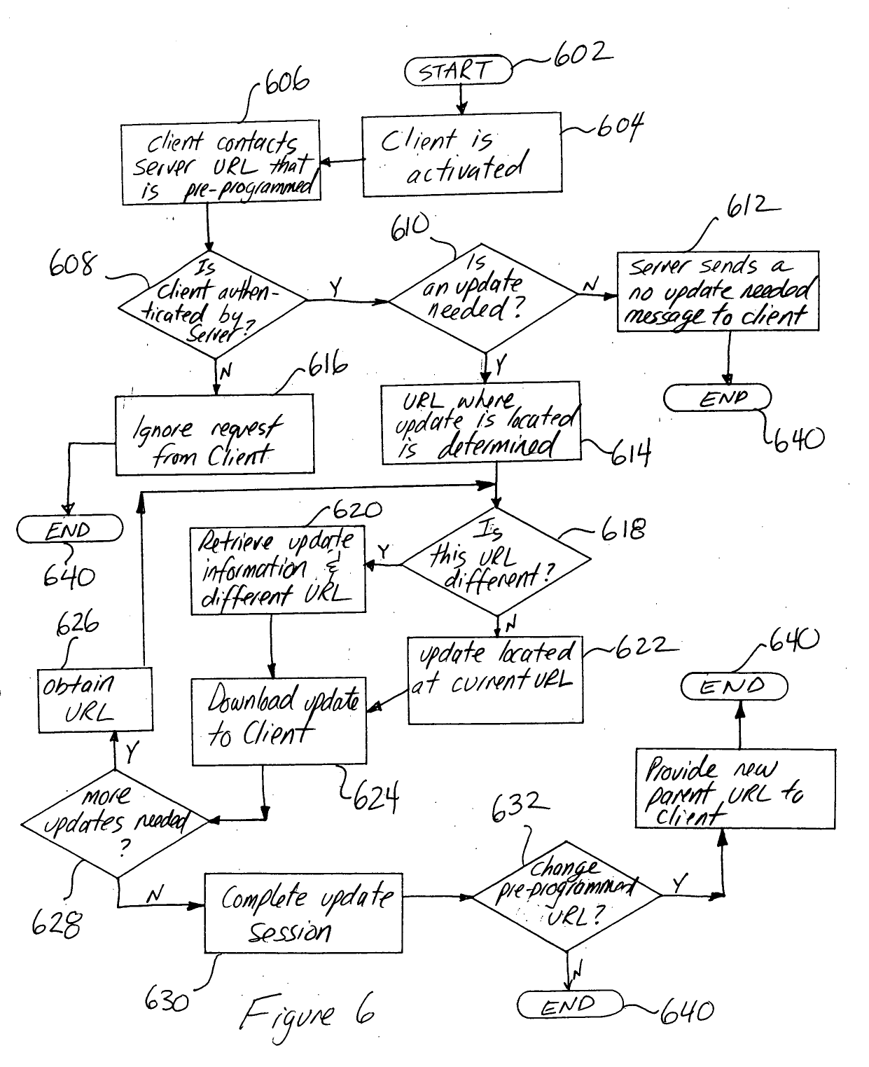

Referring now to FIG. 5, a sequence diagram is shown for a customer that has installed the roaming client application but has not used it yet. Now that the customer is at a supported hotspot, he is either prompted for connection if the client is already running or launches the application with the intention of connecting to the Internet. The sequence diagram in FIG. 5, above, shows the steps entailed in the process of registering for an account, purchasing service, and getting connected to the Internet. The following is a list of steps that define interaction between script of the steps in that sequence:

At step 1 of FIG. 5, the application of the present invention creates a HTTP GET to a URL outside the walled garden (white list) in order to extract provider and location information.
GET/HTTP/1.0
User-Agent: Mozilla/4.0 (compatible; MSIE 5.5; Windows NT 5.0)-
APPLICATION/1.0
Host: www.outsidewalledgarden.com

At step 2, the application parses HTTP response and stores provider, location, error and other provided information (the implementation of this step is provider/NAS specific).

HTTP/1.0 302 Found
Server: MC SSG/0.0.0 (Linux)
Location: http://location1.mc.com/cgi-bin/index.cgi?
MacAddr=00-06-25-0D-3A-24&lpAddr=216.12.231.204
...
<!-- ServiceProvider=My Carrier -->
<!-- access location=mc1 -->
<!-- error=0 -->
<!-- LoginURL=https://login1.carrier.com/Login -->
<HTML>
...
</HTML>

At step 3, the application POSTs information to the Web Portal about the current status, location, etc.

```
POST /Welcome.jsp HTTP/1.0
User-Agent: Mozilla/4.0 (compatible; MSIE 5.5; Windows NT 5.0) -
APPLICATION/1.0
...
Host: portal.pctel.com
APPLICATION=*⁾
<Application version=“1.0”>
  <status>connected</status>
  <username></username>
  <password></password>
  <error>0</error>
  <provider>A Carrier</provider>
  <location>mc1</location>
  <sessionid></sessionid>
  <ip>216.12.231.204</ip>
  <mac>00-06-25-0D-3A-24</mac>
</Application>
*⁾ POST information is formatted with CR/LF for clarity
```

At step 4, the Web Portal determines a set of actions that should be performed by the application (a standard set of actions is presented Table 1.). In this case, the carrier Web Portal sends ‘launchMiniBrowser’ action and defines URL that should be used to initiate new user sign up procedure.

```
HTTP/1.0 200 OK
...
ApplicationActions: yes
...
<!--
<Application version=”1.0”>
<actions>
  <action name=”launchMiniBrowser”>
    <parameter name=”url” type=”single”>
      <value>https://portal.carrier.com/NewUser</value>
    </parameter>
    <parameter name=”width” type=”single>
      <value>480</value>
    </parameter>
    <parameter name=”height” type=”single>
      <value>320</value>
    </parameter>
  </action>
</actions>
</Application>
-->
```

At step 5, the ‘IlaunchMiniBrowser’ action accepts three parameters: url, width and height. Width and height values are specified in pixels. The application will typically, though not necessarily, position branded Mini Browser window in the center of the user's screen. If width and height values are not provided or contain illegal values, Mini Browser window size defaults to 640×480 pixels.

At steps at 5a-5d, the portal provides one or more steps for setting up a new user account. The user has a freedom to navigate and select different options by interacting with the presented HTML pages. Branded Mini Browser is “listening” for a new set of actions that will end the sign up procedure.

At steps 6 the Web Portal returns one or more actions as part of the embedded XML. In HTTP response, ‘ApplicationActions’ custom HTTP header is set to ‘yes’—therefore, Application Client parses and executes embedded list of actions.

```
HTTP/1.0 200 OK
...
Application Actions: yes
...
<Application version=”1.0”>
  <actions>
  <action name=”confirmPassword”>
    <parameter name=”username” type=”single”>
      <value>johndoe</value>
    </parameter>
  </action>
  <action name=”login”/>
  </actions>
</Application>
```

At step 7, the APPLICATION Client attempts the login procedure after prompting the user to confirm password.

POST/roamer_login.adp HTTP/1.0
User-Agent: Mozilla/4.0 (compatible; MSIE 5.5; Windows NT 5.0) -
APPLICATION/1.0
...
Host: ssg.carrier.com
MacAddr=00:01:02:03:04:05&IpAddr=216.12.231.204&sername=johndoe
&password=johndoepass

At step 9, the system indicated if the login procedure succeeded.

HTTP/1.0 200 OK
Server: MC SSG/0.0.0 (Linux)
...
<!-- error=0 -->
<!-- SessionId=123123 -->
<!-- AuthMessage=Reply-Message -->
<!-- LogoffURL=http://ssg.pctel.com/cgi-bin/logoff.cgi -->
<HTML>
...
</HTML>

At step 9, the APPLICATION Client POSTs new status information and all relevant data to carrier Web Portal.

```
POST/LoginSuccess.jsp HTTP/1.0
User-Agent: Mozilla/4.0 (compatible; MSIE 5.5; Windows NT 5.0) -
APPLICATION/1.0
...
Host: portal.pctel.com
APPLICATION=*⁾
<Application version=”1.0”>
  <status>loggedin</status>
  <username>johndoe</username>
  <password>johndoepass</password>
  <error>0</error>
  <provider>myWISP</provider>
  <location>mc1</location>
  <sessionid>123123</sessionid>
  <ip>192.168.200.100</ip>
  <mac>00-06-25-0D-3A-24</mac>
</Application>
*⁾POST information is formatted with CR/LF for clarity
```

At step 10, the Web Portal parses APPLICATION information and determines if further actions should be performed by the authenticator. This is also a moment when customized advertisement content could be pushed back to the user.

```
HTTP/1.0 200 OK
...
APPLICATIONActions: yes
...
<Application version=”1.0”>
  <actions>
  <action name=”launchDefaultBrowser”>
    <parameter name=”url” type=”single”>
      <value>http://promotions.mycarrier.com?ad=89879</value>
    </parameter>
  </action>
  </actions>
</Application>
```

Returning User

In an example wherein the user is and already has an account, then the client will start the connection with a status update of loggedIn. This message will pass appropriate information to the central system in a manner analogous to the new user described above.

Referring now to FIG. 6, the process of updating a client begins at step 600. At step 604, the client is activated for the first time and at step 606 the client initiates a communication session with the server located at the pre-programmed URL. At step 608, the server will authenticate the client to ensure the client. If the server does not recognize the client as a client should contact this server for updates, then at step 616 the server ignores the request from the client. In addition to ignoring the request the server can also pass the identification information of the client to a central location in order to determine the cause of error, especially if this is the client's first update communication session after being activated. If the server authenticates the client, then at step 610 the client sends its information to the server, including time-date stamp information of the last update and the server determines if an update is available and needed. At step 612, if it is determined that an update is not needed, then the server informs the client that an update is not necessary and the process ends at step 640. On the other hand, if at step 610 the server or some management program determines that an update is needed, then at step 614 the URL of the location containing the update is determined. At step 618 the server determines if the URL for the update is the same as or different from its own URL. If the URL is different, then at step 620 the update is obtained from the remote URL. If the URL is the same, then at step 622 the update is located at the current server's URL. At step 624, the update is downloaded to the client. At step 628, it is determined, based on information from the client and the current update information available, if additional updates are needed. If there are additional updates, then at step 626 the URL is obtained and the process to step 618. If additional updates are not needed, then at step 630 the update session is complete.

At step 632, it is determined by the system if the parent server will not longer act as the first point of contact. If a new parent server is to be designated, then at step 636, the current parent server will provide a new URL to replace the pre-programmed URL and the client will, thereafter, initiate update communication sessions with the new parent server located at the new URL. On the other hand, if a new parent server is not needed or designated, then the current URL that is pre-programmed in the client remains unchanged at the process ends at step 640. It is worth noting that in alternative embodiments the parent server provides a new URL during the authentication step, which is at step 608, because a new parent server at a new URL has been designated since the last communication session or since the client was pre-programmed, if the first communication session has not been initiated. In this case, the server can either authenticate the client and pass the remaining portion of the communication session to the new parent server at the new URL or, in the alternative, the parent server can update the client with the new URL and instruct the client to initiated a new communication session with the new parent server.

Having fully described various embodiment and various alternatives, those skilled in the art will recognize, given the teachings herein that numerous alternatives and variations exist that do not depart from the invention. It is therefore intended that the invention not be limited by the forgoing description and only by the following claims.

1. A method of updating a client comprising the steps of:
initiating communication from the client to a parent server;
determining if the client has the most recent update; and
downloading the update information to the client.

2. The method of claim 1 wherein the step of determining comprises the steps of:
comparing the time stamp information of the information at the client with the time stamp information of the current update available at the server;
transmitting the update information from the server to the client if the time stamp information at the client indicated that the information at the client is not the most recent update; and
transmitting an indicator from the server to the client in order to indicate that the client has the most recent update and an update is not necessary.

3. The method of claim 2, wherein the server provide the URL address for the location of the update in order for the client to initiate communication with a secondary server where the update resides.

4. The method of claim 2, wherein the parent server contain the update information.

5. The method of claim 2, wherein the step of initiating communication is a wireless communication session and the client is a wireless device.

6. The method of claim 1, wherein the initiating step comprises the steps of:
preprogramming the URL address of the parent server; and
authenticating the client at the server in order to ensure the client is initiating contact with the parent server.

7. The method of claim 6, further comprising the step of routing the client to an alternative parent server if the parent server can not authenticate the client due to a change in the designation of the server that the client should contact since the last communications session.

8. The method of claim 1, wherein the parent server provides a new URL to the client for a second server that will become a new parent server.

9. The method of claim 1 wherein the client automatically initiates an update communication session.

10. The method of claim 1 wherein initiating a communication session is done by a user of the client.

11. The method of claim 1, wherein the step of initiation includes the step of authentication of the client over a secure connection.

12. A system for updating a device, the system comprising:
a device having at least one updatable component and capable of transmitting authentication information; and
a server in communication with the device, wherein the server is capable of downloading updates to the device when the device has been authenticated by the server.

13. The system of claim 12 further comprising means for transmitting secure information over a network.

14. The system of claim 12 wherein the device is a wireless device.

15. The method of claim 14 wherein the communication session occurs over an intranet network.

16. The method of claim 14 wherein the communication session occurs over an internet network.

17. The system of claim 12 comprising at least one additional server in communication with the server, wherein the at least one additional server contains update information that is transmitted to the client.

18. The system of claim 12 further comprising an updater unit couple to the server and in communication with the client for storing the location of a plurality of updates as well as information relating to time stamp for plurality of updates.

19. The system of claim 18, wherein the updater communicates with the client over a wireless communication link.

20. A system for updating a client in wireless communication with a parent server, the system comprising:
means for initiating communication from the client to the parent server;
means for determining if the client has the most recent update, wherein
means for determining comprises:
means for comparing the time stamp information of the information at the client with the time stamp information of the current update available at the server;
means for transmitting the update information from the server to the client if the time stamp information at the client indicated that the information at the client is not the most recent update; and
means for transmitting an indicator from the server to the client in order to indicate that the client has the most recent update and an update is not necessary; and
means for downloading the update information to the client.
